(19) United States
(12) Patent Application Publication
(10) Pub. No.: US 2025/0223944 A1
(43) Pub. Date: Jul. 10, 2025

(54) COMPUTER-BASED MODULATING OF WIND SPEED TO MAXIMIZE POWER GENERATION BY A VEHICLE

(71) Applicant: International Business Machines Corporation, Armonk, NY (US)

(72) Inventors: Fang Lu, Billerica, MA (US); Jeremy R. Fox, Georgetown, TX (US); Martin G. Keen, Cary, NC (US); Sarbajit K. Rakshit, Kolkata (IN)

(21) Appl. No.: 18/408,084

(22) Filed: Jan. 9, 2024

(51) Int. Cl. F03D 7/04; B62D 35/00; F03D 7/02; F03D 9/32

(52) U.S. Cl. CPC F03D 7/046; B62D 35/00; F03D 7/028; F03D 9/32; F05B 2260/84; F05B 2270/1033; F05B 2270/32

(57) ABSTRACT

In an approach to improve power generation in both manual and autonomous vehicles embodiments of the present invention measure, by a set of sensors, a wind speed as it passes through a funnel system. Further, embodiments modulate, by the funnel system, the wind speed of wind that passes through the funnel system to a turbine array, where modulating the wind speed comprises adjusting, by a motor set, a cross-sectional area of an entry portion and an exit portion of the funnel system based on the measured wind speed. Additionally, embodiments proactively adjust, by the computing system, the funnel system to maintain a predetermined wind speed that is being fed to the turbine array through the funnel system by employing machine learning models and control algorithms, using sensor data, vehicle to everything communication, and predictive analysis of wind patterns and road conditions.

### BACKGROUND OF THE INVENTION

The present invention relates generally to vehicles, and more particularly to the field of power generation by motorized or mechanical vehicles.

Wind turbines generate power by converting the kinetic energy of wind into mechanical energy, which is then transformed into electrical energy. One of the fundamental principles that govern the operation of wind turbines is Bernoulli's theorem. This theorem explains the relationship between the pressure, velocity, and elevation in a moving column of fluid, which, in our case, is air. As per the theorem, as the velocity of a fluid increases, its pressure decreases, and conversely, when the velocity decreases, the pressure increases. In the context of wind turbines, wind speed plays a major role in electricity generation. The amount of electricity generated by a turbine is mostly determined by the wind's speed due to the cubic relationship between them. Even a small increase in wind speed leads to a substantial increase in power output. Wind speeds are influenced by various factors, such as weather conditions and geographical location, making it quite difficult to maintain the wind speed within this operational range.

### SUMMARY

Embodiments of the present invention disclose a computer-implemented method, a computer program product, and a system, for improving power (e.g., energy) generation in vehicles, the computer-implemented method comprising: measuring, by a set of sensors, a wind speed as it passes through a funnel system, modulating, by the funnel system, the wind speed of wind that passes through the funnel system to a turbine array, wherein modulating the wind speed comprises: adjusting, by a motor set, a cross-sectional area of an entry portion and an exit portion of the funnel system based on the measured wind speed, and proactively adjusting, by the computing system, the funnel system to maintain a predetermined wind speed that is being fed to the turbine array through the funnel system by employing machine learning models and control algorithms, using sensor data, vehicle to everything communication, and predictive analysis of wind patterns and road conditions.

Embodiments of the present invention further disclose an array of wind turbines, embedded into the body of an autonomous vehicle, wherein the array of wind turbines generate power when exposed to wind and their operational range is defined by specific cut-in and cut-out wind speeds, wherein each turbine in the array of wind turbines is constructed out of lightweight composite material and strategically positioned to reduce aerodynamic drag while maximizing wind exposure. Embodiments of the present invention disclose a funnel system is located in front of the array of wind turbines, and wherein the motor system comprises high-torque servo motors. Embodiments of the present invention disclose utilizing Bernoulli's theorem to calculate the size or shape of the cross-sectional area of the funnel system to maintain the wind speed within an operational range of the turbines to maximize power generation when adjusting the cross-sectional area. Embodiments of the present invention disclose that the set of sensors comprise anemometers, wherein the anemometers are located at the entry portion and exit portion of the funnel system. Embodiments of the present invention disclose that the computing system is embedded and integrated into the vehicle and is designed to process sensor data in real-time. Embodiments of the present invention disclose collecting, by the sensor set, data associated with the wind speed and the road conditions to provide real-time data to the computing system; and utilizing the collected data to predict wind patterns and road conditions in real-time by employing machine learning models, control algorithms, vehicle-to-everything (V2X) communication, and predictive analysis.

### BRIEF DESCRIPTION OF THE DRAWINGS

FIG. 1A is a functional block diagram illustrating a distributed data processing environment, executing an optimization program, in accordance with an embodiment of the present invention;

FIG. 1B illustrates a functional block diagram and operational steps of the optimization program, on a server computer within the distributed data processing environment of FIGS. 1A, in accordance with an embodiment of the present invention;

FIG. 2 is a functional block diagram illustrating a distributed data processing environment in accordance with an embodiment of the present invention;

FIG. 3A is a functional block diagram illustrating a distributed data processing environment in accordance with an embodiment of the present invention;

FIG. 3B is a functional block diagram illustrating a distributed data processing environment in accordance with an embodiment of the present invention;

FIG. 3C is a functional block diagram illustrating a distributed data processing environment in accordance with an embodiment of the present invention;

FIG. 3D is a functional block diagram illustrating a distributed data processing environment in accordance with an embodiment of the present invention; and

FIG. 4 illustrates operational steps of the optimization program, on a server computer within the distributed data processing environment of FIGS. 1A, in accordance with an embodiment of the present invention.

### DETAILED DESCRIPTION

According to an aspect of the invention, there is a provided computer-implemented method, computer system, and computer program product to measure, by a set of sensors, a wind speed as it passes through a funnel system, modulate the wind speed of wind that passes through the funnel system to a turbine array by adjusting a cross-sectional area of an entry portion and an exit portion of the funnel system using a motor set based on the measured wind speed, and proactively adjusting the funnel system to maintain a predetermined wind speed that is being fed to the turbine array through the funnel system by employing machine learning models and control algorithms, using sensor data, vehicle to everything communication, and a predictive analysis of wind patterns and road conditions. The entire aspect of the invention, detailed above, might cause improved power generation by maximizing power production of turbine arrays.

According to an aspect of the invention, the provided computer-implemented method, computer system, and computer program product may further comprise an array of wind turbines, embedded into the body of a vehicle, wherein the array of wind turbines generate power when exposed to wind and an operational range of the array of wind turbines is defined by specific cut-in and cut-out wind speeds where each turbine in the array of wind turbines is constructed out of lightweight composite material and strategically positioned to reduce aerodynamic drag while maximizing wind exposure. In embodiments, the use of the integrated array of wind turbines may, at least, advantageously increase energy production while a vehicle is operation.

In embodiments, the funnel system is located in front of the array of wind turbines where the motor system comprises high-torque servo motors. In embodiments, the positioning of the funnel system and use of high-torque servo motors may, at least, advantageously increase the efficiency and accuracy of controlling the wind speed passing through the funnel system.

In embodiments, adjusting the cross-sectional area comprises utilizing Bernoulli's theorem to calculate the size or shape of the cross-sectional area of the funnel system to maintain the wind speed within an operational range of the turbines to maximize power generation. In embodiments, adjusting the cross-sectional area may, at least, advantageously improve the efficiency and accuracy of controlling the wind speed passing through the funnel system.

In embodiments, set of sensors comprise anemometers, where the anemometers are located at the entry portion and exit portion of the funnel system. I embodiments the location of the anemometers may, at least, advantageously improve the efficiency and accuracy of controlling the wind speed passing through the funnel system.

In embodiments, the computing system is embedded and integrated into the vehicle and is designed to process sensor data in real time. In embodiments, the real time data processing may, at least, advantageously improve the efficiency and accuracy power generation and control of wind speed passing through the funnel system to the turbine array.

In embodiments, the provided computer-implemented method, computer system, and computer program product collect, through the sensor set, data associated with the wind speed and the road conditions to provide real-time data to the computing system, and utilize the collected data to predict wind patterns and road conditions in real-time by employing machine learning models, control algorithms, vehicle-to-everything (V2X) communication, and predictive analysis. In embodiments, the predicting of wind patterns and road conditions based on collected data may, at least, improve efficiency and accuracy power generation and control of wind speed passing through the funnel system to the turbine array to ensure an optimal wind speed and power generation by the turbine array is maintained.

Embodiments of the present invention recognize that wind turbines cannot operate at extremely high or low wind speeds. Embodiments of the present invention recognize that wind turbines have specific cut-in and cut-out speeds, representing the minimum and maximum wind speeds at which the turbines can operate, respectively. Therefore, embodiments of the present invention recognize that, maintaining optimal wind speed is essential for the efficient operation of wind turbines. Below the cut-in speed, embodiments of the present invention recognize that the turbine cannot generate power, and above the cut-out speed, embodiments of the present invention recognize that the turbine must be stopped to prevent damage. Embodiments of the present invention recognize that wind speeds are influenced by various factors, such as weather conditions and geographical location, making it quite difficult to maintain the wind speed within this operational range. Given these complexities, Embodiments of the present invention recognize that there is a pressing need for a system that can effectively modulate wind speed to optimize power generation from wind turbines.

Embodiments of the present invention recognize that the proliferation of autonomous vehicles (AVs) in sectors such as public transit, logistics, and urban air mobility has triggered the need for energy-efficient solutions. At least one approach in the art is integrated turbines. Integrated turbines operate within specific wind speed parameters, known as cut-in and cut-out speeds. However, embodiments of the present invention recognize that maintaining these speeds is challenging due to the unpredictable nature of wind and the variable speed of the vehicle.

Embodiments of the present invention recognize that constant adjustments of the vehicle's speed to control the relative wind speed is neither feasible nor efficient in the art. Furthermore, embodiments of the present invention recognize that vehicle-to-Everything (V2X) technology, which facilitates data exchange amongst vehicles and infrastructure, adds another layer of complexity. Thus, embodiments of the present invention recognize that there is a need in the current art for a sophisticated solution capable of managing variables, discussed above, and maximizing the potential of wind-powered energy generation in AVs.

Embodiments of the present invention, improve the art and solve at least the issues stated above by enabling an autonomous vehicle to generate power by using an array of wind turbines embedded into the body of the autonomous vehicle, and further employing a programmable funnel module within the autonomous vehicle to adjust wind speed within the operational range of the turbines. More specifically, embodiments of the present invention improve the art and solve at least the issues stated above by (i) generating power using the array of wind turbines integrated into a vehicle by utilizing Bernoulli's theorem to maintain the wind speed within operational range defined by specific cut-in and cut-out wind speed; (2) utilizing the programmable funnel module located in front of wind turbines to adjust the cross-sectional area of the funnel's entry and exit points in real-time using high-torque servo motors; (3) collecting data of the wind speed and road conditions via sensors and anemometers to provide real-time data to a vehicle's computing system; and (iv) predicting wind patterns and road conditions in real-time by employing machine learning models, control algorithms, Vehicle-to-everything (V2X) communication, and predictive analysis to proactively adjust the funnel module in order to maximize the power generation.

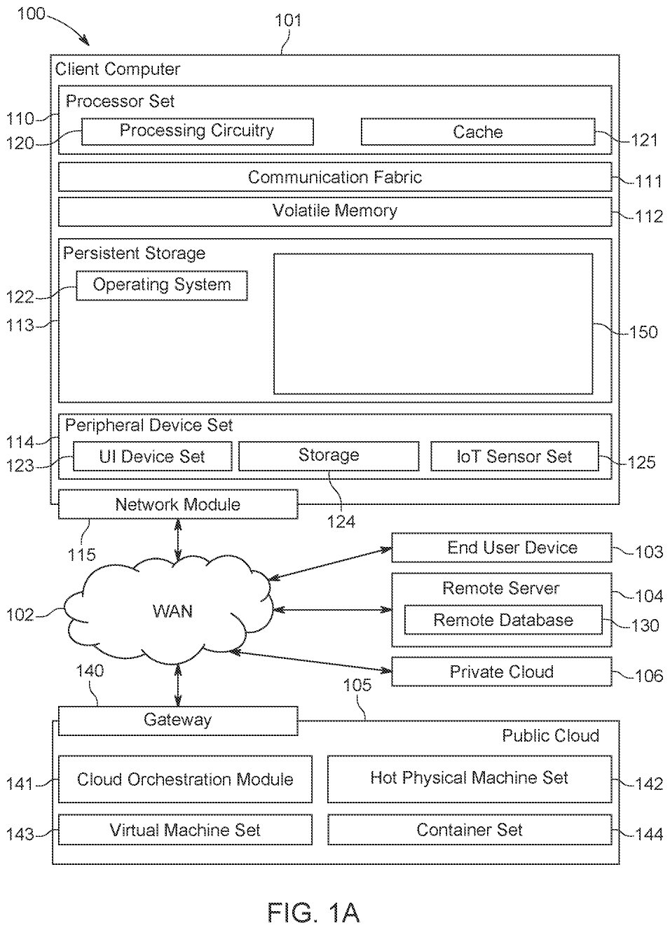

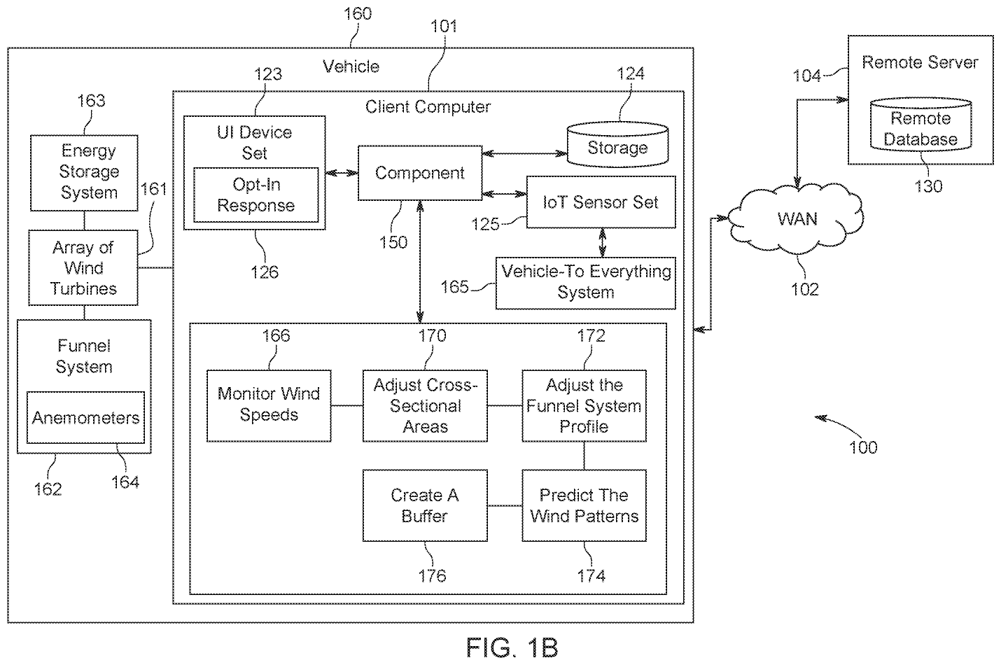

Implementation of embodiments of the invention may take a variety of forms, and exemplary implementation details are discussed subsequently with reference to the Figures (i.e., FIG. 1A-FIG. 4).

It should be noted herein that in the described embodiments, participating parties have consented to being recorded and monitored, and participating parties are aware of the potential that such recording and monitoring may be taking place. In various embodiments, for example, when downloading or operating an embodiment of the present invention, the embodiment of the invention presents a terms and conditions prompt enabling the user to opt-in or opt-out of participation. Similarly, in various embodiments, emails, and texts, and/or responsive display prompts begin with a written notification that the user's information may be recorded or monitored and may be saved, for the purpose of consolidating shipments to reduce carbon emissions and shipping costs. These embodiments may also include periodic reminders of such recording and monitoring throughout the course of any such use. Certain embodiments may also include regular (e.g., daily, weekly, monthly) reminders to the participating parties that they have consented to being recorded and monitored for collision avoidance and autonomous vehicle safety measures and may provide the participating parties with the opportunity to opt-out of such recording and monitoring if desired.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 100 contains an example of an environment for the execution of at least some of the computer code involved in performing the inventive methods, such as optimization program (component) 150. In addition to component 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and component 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in component 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in component 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector. IoT sensor set 125 may be any combination of proximity sensors, image sensor, motion sensor, thermistor, capacity sensing, photoelectric sensor, infrared sensor, level sensor, humidity sensor, pressure sensor, temperature sensor, and/or any sensor and/or IoT sensor known and understood in the art.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, central processing unit (CPU) power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In various embodiments, component 150 enables autonomous vehicles to generate power using an array of wind turbines, modulating the relative wind speed via a programmatically controlled funnel system. In some embodiments, the funnel system is a programmatic funnel system. In various embodiments, the turbines may be integrated into the autonomous vehicle. Component 150 may combine sensor technology, control algorithms, and vehicle-to-everything (V2X) collaboration, predicting and adapting to changes in wind speed and direction, vehicle speed, and road conditions to optimize power generation. V2X communication uses WLAN technology and works directly between vehicles (V2V) as well as vehicles and traffic infrastructure (V2I), which form a vehicular ad-hoc network as two V2X senders come within each other's range. V2X encompasses both V2V and V2I technology. V2X communication may enable seamless integration and communication between vehicles and the surrounding infrastructure of a vehicle. In this case, V2I integration refers to the exchange of information between vehicles and the infrastructure, such as traffic signals, road signs, and transportation management systems. By analyzing the surrounding infrastructure, component 150 may analyze and predict the power that can be generated through the turbines (e.g., predict the amount of potential wind speed based on traffic conditions and weather conditions).

In various embodiments, not depicted in FIG. 1 but further described below, component 150 comprises an array of wind turbines, embedded into the body of an autonomous vehicle. In various embodiments, each turbine is made of lightweight composite material and strategically positioned to reduce aerodynamic drag while maximizing wind exposure. These turbines generate power when exposed to wind, wherein the operational range of the turbines are defined by specific cut-in and cut-out wind speeds. In other embodiments, the operational range of the turbines are predetermined. The array of wind turbines uses the kinetic energy from the wind to generate electricity. The array of wind turbines is placed on the vehicle to capture maximum wind while minimizing the impact on vehicle aerodynamics.

Further, in various embodiments, not depicted in FIG. 1A but further described below, component 150 comprises funnel system, located in front of the turbine array, designed to modulate the wind speed that reaches the turbines. In various embodiments, the funnel system is utilized to control the wind speed hitting the one or more turbines in the turbine array. In various embodiments, the funnel system adjusts the cross-sectional area of the funnel's entry and exit points in real time, based on the relative wind speed, using a motor system (e.g., high-torque servo motors). The funnel system may utilize Bernoulli's theorem to maintain the wind speed within the operational range of the turbines, thereby maximizing power generation by manipulating the profile of the funnel system to increase, decrease, or maintain the wind speed being fed to the turbine array.

Additionally, in various embodiments, not depicted in FIG. 1 but further described below, component 150 comprises a set of sensors (e.g., anemometers), located at the entry and exit points of the funnel system, tasked with measuring the wind speed. These sensors provide real-time data to the vehicle's computing system (e.g., client computer 101). The computing system may serve as the brain of the system. In various embodiments, the computing system receives inputs from the wind speed sensors, information about vehicle speed, and data from V2X systems for wind direction, vehicle direction, and forecasted weather conditions. The computing system may calculate the optimal cross-sectional area of the funnel for the given circumstances and sends commands to the motors controlling the funnel's shape. In various embodiments, computing system may utilize Bernoulli's theorem to calculate the optimal cross-sectional area of the funnel for the given circumstances.

Further, in various embodiments, not depicted in FIG. 1 but further described below, component 150 comprises an embedded high-performance computing system, integrating into the vehicle, designed to process sensor data in real time, control the funnel system, and manage power distribution. Component 150 may employ machine learning models and control algorithms, using sensor data, V2X communication, and predictive analysis of wind patterns and road conditions to proactively adjust the funnel system. In various embodiments, component 150, via embedded high-performance computing system, receives inputs from the wind speed sensors, information about vehicle speed, and data from V2X systems for wind direction, vehicle direction, and forecasted weather conditions. It calculates the optimal cross-sectional area of the funnel for the given circumstances and sends commands to the motors controlling the funnel's shape.

In various embodiments, component 150 improves the art by maximizing power generation in autonomous vehicles using an array of wind turbines and a programmatically controlled funnel to modulate relative wind speed. In various embodiments, the funnel, capable of adjusting its cross-sectional area, via component 150, along with wind speed sensors, enables the system to maintain optimal turbine operation range under varying wind and vehicle conditions. Component 150 may utilize real-time data and forecasted data to optimize wind speed and power generation.

FIG. 1B is a functional block diagram illustrating a distributed data processing environment, generally designated 100, in accordance with one embodiment of the present invention. The term “distributed” as used in this specification describes a computer system that includes multiple, physically distinct devices that operate together as a single computer system. FIG. 1B provides only an illustration of one implementation and does not imply any limitations with regard to the environments in which different embodiments may be implemented. Many modifications to the depicted environment may be made by those skilled in the art without departing from the scope of the invention as recited by the claims. Distributed data processing environment 100 includes vehicle 160, and remote server 104 interconnected via WAN 102.

In the depicted embodiment, vehicle 160 comprises client computer 101, array of wind turbine(s) 161, funnel system 162, and energy storage system 163. In various embodiments, via UI device set 123, component 150 issues and/or receives permission from a user/operator of IoT sensor set 125 to track and/or monitor vehicle 160 (i.e., receive opt-in response 126), wherein opt-in response 126 grants permission for component 150 to access and monitor sensors associated with monitoring and/or maintaining vehicle 160 (e.g., IoT sensor set 125, anemometers 164, and vehicle-to-everything system (V2X) 165).

In various embodiments, array of wind turbines (turbine(s)) 161 are embedded into the body of vehicle 160. Vehicle may be a traditional motor or manually powered vehicle as it is known and understood in the art that can be controlled and/or operated by a user or artificial intelligence system (e.g., motor vehicle and/or autonomous vehicle). Each turbine 161 may composed of lightweight composite material as they are known and understood in the art (e.g., glass fiber-reinforced polymer) and strategically positioned, based on identified aerodynamic features of a vehicle, to reduce aerodynamic drag while maximizing wind exposure. In some embodiments, turbine(s) 161 are positioned in a staggering position or a symmetric formation to reduce aerodynamic drag while maximizing wind exposure. In some embodiments, component 150 may dynamically adjust the position of turbine(s) 161, via a motorized base coupled to turbine(s) 161. These turbines generate power when exposed to wind, wherein an operational range for turbine(s) 161 may be defined by a specific cut-in and cut-out wind speeds. In the depicted embodiment, the power (i.e., energy) generated by the wind exposure to turbine(s) 161 is stored on energy storage system 163. In various embodiments, component 150 monitors and identifies, via IoT sensor set 125, the amount of power generated by turbine(s) 161. In some embodiments, turbine(s) 161 are designed to generate maximum power within the specific cut-in wind speed of −3 m/s and cut-out wind speed of −25 m/s.

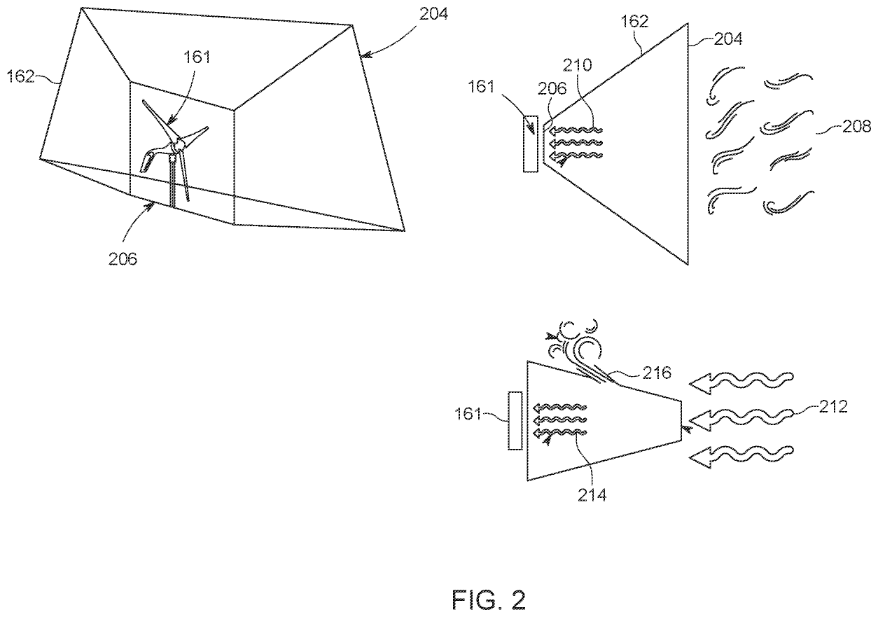

In the depicted embodiment, funnel system 162 is positioned in front of turbine(s) 161. In various embodiments, funnel system 162 is a programmatic system. Funnel system 162 may dynamically modulate the wind speed that reaches turbine(s) 161 (further described in FIG. 2). In various embodiments, the cross-sectional area of the entry and exit points of funnel system 162 are adjustable, wherein based off data collected from IoT sensor set 125 and/or anemometers 164 component 150 can adjust the entry and exit points of funnel system 162 in real time using high-torque servo motors. Funnel system 162, via component 150, may utilize Bernoulli's theorem to dynamically adjust the entry and exit points of funnel system 162 to maintain a predetermined wind speed within the operational range of the turbines, thereby maximizing power generation. In the depicted embodiment, funnel system 162 comprises anemometers 164. In various embodiments, anemometers 164 are located at the entry and exits points of funnel system 162 to monitor and measure wind speeds in real-time. Component 150 may utilize funnel system 162 to direct and a predetermined wind speed into turbine(s) 161 to ensure turbine(s) 161 maintain a predetermined speed (e.g., staying within the cut-in and cut-out speeds). In various embodiments, component 150 may utilize funnel system 162 to direct and a predetermined wind speed into turbine(s) 161 to generate a predetermined amount of energy (e.g., electrical power). In various embodiments, the power generated by turbine(s) 161 feeds into the vehicle's electrical system and is either stored in energy storage system 163 for future use or immediately used to power various systems (e.g., motor(s)) and/or subsystems (e.g., lighting and air conditioning).

In the depicted embodiment, component 150 monitors, via anemometers 164, wind speeds 166 associated with vehicle 160 as vehicle 160 is traveling. In the depicted embodiment, component 150 adjusts cross-sectional areas 170 of funnel system 162 based on Bernoulli's theorem and the monitored wind speeds 166 to maintain optimal wind speed and maximize power generation. In the depicted embodiment, component 150 adjusts funnel system profile 172, based on identified wind speed and identified power generation, to regulate and/or maintain optimal wind speed feed to turbine(s) 161 (i.e., to maintain optimal blade rotation of the turbine). In various embodiments, if component 150 determines the wind speed is less than an identified cut-in-feed then component 150 adjusts the funnel systems profile 172 by expanding the entry cross-section of funnel system 162 and reducing the exit of funnel system 162 to increase the amount of wind and wind speed feed to turbine(s) 161. In various embodiments, if component 150 determines that the wind speeds are above the cut-out-speed, associated with turbine(s) 161, then component 150 adjusts the funnel systems profile 172 by constricting the entry cross-section of funnel system 162 and increasing the exit of funnel system 162 to reach or maintain a predetermined wind speed.

In various embodiments, during operation of vehicle 160 (e.g., transit) component 150, via V2X 165 collaboration, adjusts the funnel system profile based on measured and/or identified wind speed, and the identified direction and speed of both vehicle 160 and the wind. For example, if vehicle 165 is traveling at 75 kilometers per hour (km/h) to a downtown area and component 150 identifies, based on V2X communication with vehicles heading to the downtown area and/or that are in the downtown area, that traffic is moving at a rate of 48 km/h then component will adjust the funnel system profile by widening the entry point and narrowing the exit point of the funnel system to account for the lower wind speed and to ensure the turbine speed remains within a predetermined range. In the depicted embodiment, component 150 predicts the wind patterns 174. Component 150 may leverage satellite technology, as it known and used in the art today, to estimate winds by tracking the motion of clouds (or water vapor features in the absence of clouds) from a sequence of satellite images, and/or receive communication from a weather service. In various embodiments, component 150, based on received weather conditions from a weather service system, the predicted wind patterns, and road inclination, creates a buffer 176 against gusts of wind that might affect the rotational speed of turbine(s) 161 (e.g., exceed the cut-out speed) by proactively adjusting the profile of the funnel system to account for the gust of wind and to ensure the turbine speed remains within a predetermined range. In various embodiments, component 150 may proactively adjust the profile of the funnel system by continuously monitoring data and continuously calculating the size and/or shape of the cross-sectional area of the funnel based on the monitored data, and creating an executable queue of actions to adjust the funnel system based on the calculation an monitored and/or received input data.

FIG. 2 is a functional block diagram illustrating one embodiment of the present invention. FIG. 2 provides only an illustration of one implementation and does not imply any limitations with regard to the environments in which different embodiments may be implemented. Many modifications to the depicted environment may be made by those skilled in the art without departing from the scope of the invention as recited by the claims.

In the depicted embodiment, funnel system 162 is placed in front of turbine 161. Funnel system 162 comprises entry cross section area 204 and exit cross section area 206, wherein entry cross section area 204 is the front of funnel system 162 and exit cross section area 206 is at the rear of funnel system 162. In the depicted embodiment, responsive to low wind speed 208 (i.e., wind speed below a predetermined threshold) cross section area 204 is increased and the exit cross section area 206 is decreased to produce increased wind speed 210, wherein increased wind speed 210 is feed to turbine(s) 161, and wherein increased wind speed 210 is comparatively higher that low wind speed 208 but is still aligned with an identified optimum wind speed to maximize power generation by turbine(s) 161.

In the depicted embodiment, responsive to strong wind 212 (e.g., wind speed above a predetermined threshold) being detected or entering funnel system 162, cross section area 204 is constricted (e.g., narrowed) to limit air flow intake into funnel system 162 and exit cross section area 206 is either widened, narrowed, or maintained at a current position so that optimum wind speed (i.e., optimum air flow) 214 is maintained and feed to turbine(s) 161. In the depicted embodiment, along with altering cross section area 204, air is released from one or more venting components 216 on funnel system 162.

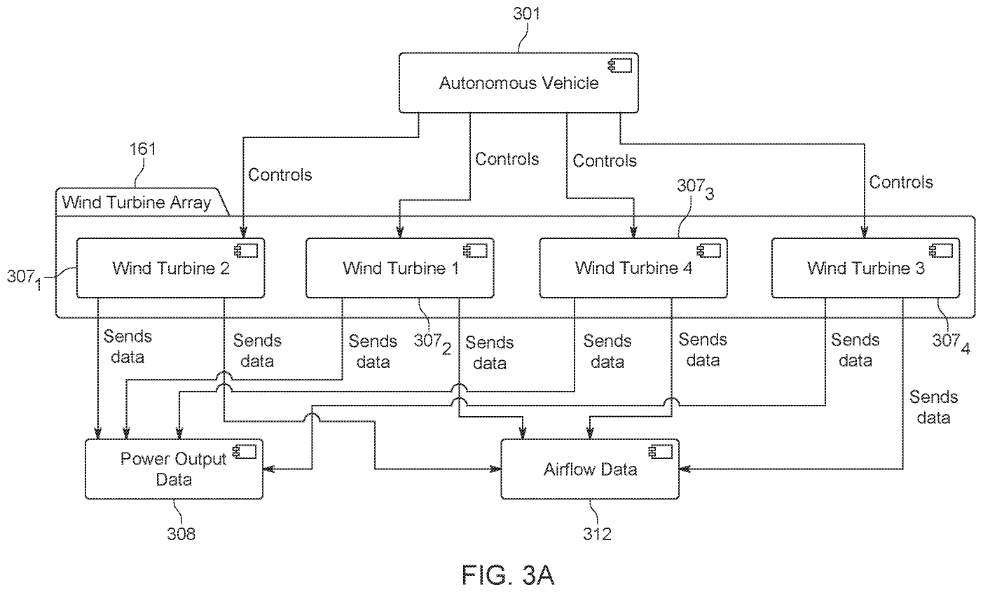

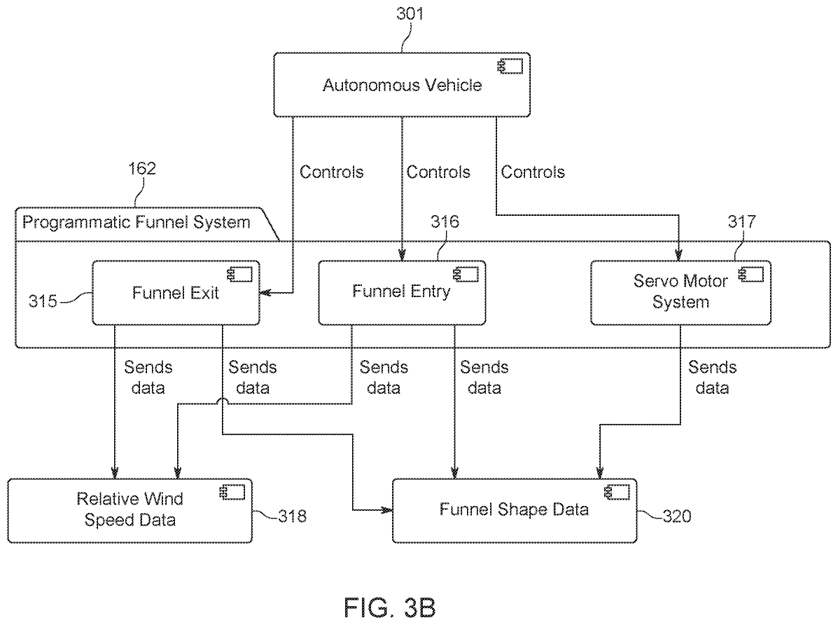

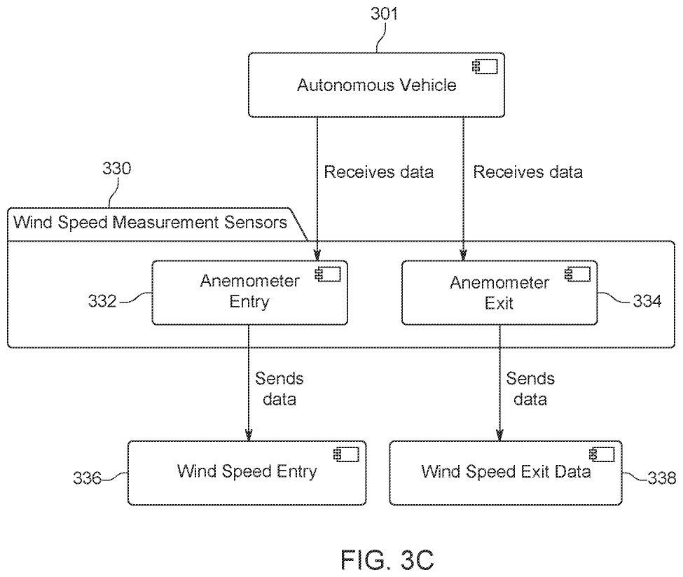

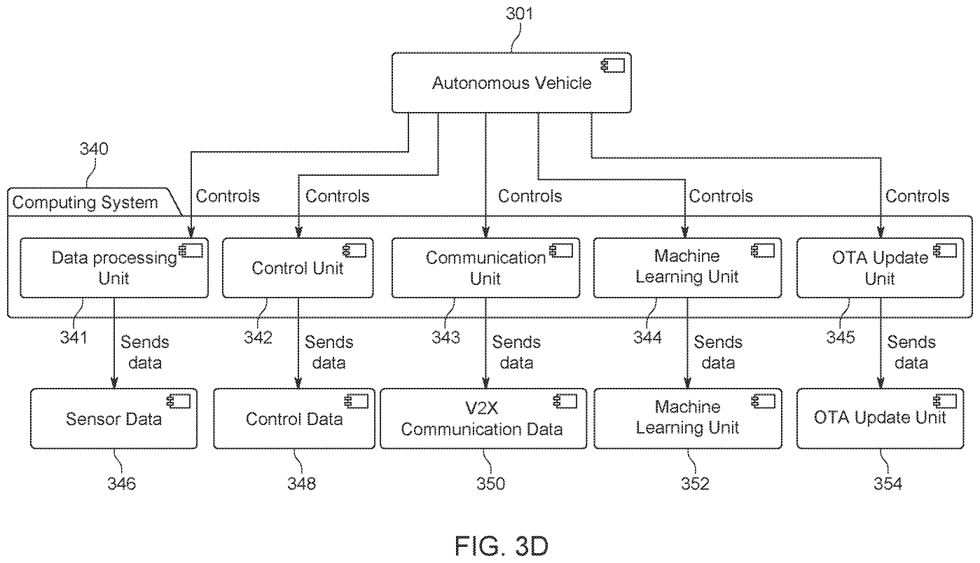

FIG. 3A is a functional block diagram illustrating one embodiment of the present invention. FIG. 3A provides only an illustration of one implementation and does not imply any limitations with regard to the environments in which different embodiments may be implemented. Many modifications to the depicted environment may be made by those skilled in the art without departing from the scope of the invention as recited by the claims.

In the depicted embodiment, wind turbine array 306 comprises wind turbine 3071-3044, hereinafter collected referred to as wind turbine(s) 307. In various embodiments, turbine(s) 307 are arranged in a staggered array on the roof and sides (i.e., body) of vehicle 301, enabling wind turbine array 306 to capture maximum wind while minimizing aerodynamic drag and maintaining the aesthetics of vehicle 301. In various embodiments, wind turbine(s) 307 are made from a durable, lightweight composite material (e.g., carbon fiber) that can handle various weather conditions and wind speeds. Turbine(s) 307 may be designed to generate maximum power within the specific cut-in wind speed of −3 m/s and cut-out wind speed of −25 m/s. In the depicted embodiment, responsive to air flow interacting with wind turbine(s) 307 to generate power, each wind turbine(s) 307 creates and sends power output data 308 and airflow data 312 to a computing system, not depicted in FIG. 3A, that is embedding in vehicle 301. Power output. data 308 and airflow data 312 may be used to calculate how much power can generate for the vehicle and how long that power can last, based on the current speed of the vehicle. In various embodiments, the power generated by turbine array 306 feeds into the vehicle's electrical system and is either stored in the onboard battery for future use or immediately used to power various subsystems.

FIG. 3B is a functional block diagram illustrating one embodiment of the present invention. FIG. 3B provides only an illustration of one implementation and does not imply any limitations with regard to the environments in which different embodiments may be implemented. Many modifications to the depicted environment may be made by those skilled in the art without departing from the scope of the invention as recited by the claims.

In the depicted embodiment, funnel system 162 comprises funnel exit 315, funnel entry 316, and servo motor system 317. In various embodiments, funnel system 162 is integrated into the body of vehicle 301. In various embodiments, autonomous vehicle 301 controls funnel system 162, via component 150. In various embodiments, funnel system 162 comprises an adjustable funnel designed with a rectangular cross-section that is integrated on the body of vehicle 301, a predetermined distance, in front of the wind turbine array, wherein the size of the funnel system correlates with the array's dimensions and its shape is streamlined to minimize turbulence. In various embodiments, funnel system 162 is mounted, a predetermined distance, in front of the wind turbine array. In various embodiments, servo motor system 317 is coupled to funnel entry 316 and funnel exit 315, wherein servo motor system 317 alters the cross-sectional area of funnel system 162 by contracting and expanding funnel exit 315 and funnel entry 316 based on data received and produced by one or more wind speed measurement sensors. In various embodiments, servo motor system 317 alters the cross-sectional area of funnel system 162 in response to a command based on received data from a computing system integrated into vehicle 301. In various embodiments, funnel system 162 is calibrated to ensure the funnel adjustments correlate precisely with the input commands from the vehicle's computing system.

In various embodiments, servo motor system 317 is a plurality of high-torque, fast-responding servo motors that are utilized for adjusting and/or manipulating funnel system 162. Servo motor system 317 may provide speed and precision for the real-time alterations of the cross-sectional area of funnel system 162. PID (Proportional Integral Derivative) control algorithms may be used to manage the operation of servo motor system 317 to ensure the precise positioning of funnel system 162 based on the commands from the vehicle's computing system. In various embodiments, a real-time operating system is used to manage the control algorithm's operation and ensure real-time response to changes in wind speed or vehicle speed. In various embodiments, the communication between funnel system 162 and the computing system of vehicle 301 is established using standard protocols like CAN (Controller Area Network) to ensure reliable real-time control. In the depicted embodiment funnel system generates funnel shape data 320 based on the adjustments made to funnel exit 315, funnel entry 316, and the cross-sectional area by the servo motor system 317. Further, in the depicted embodiment, responsive to wind flowing through funnel system 162, funnel system monitors, generates, and/or reports wind speed data as wind flows through funnel system 162 (e.g., funnel entry 316 and funnel exit 315). Funnel shape data 320 and wind speed data may be utilized to calculate the amount of power that can be generated for the vehicle.

FIG. 3C is a functional block diagram illustrating one embodiment of the present invention. FIG. 3C provides only an illustration of one implementation and does not imply any limitations with regard to the environments in which different embodiments may be implemented. Many modifications to the depicted environment may be made by those skilled in the art without departing from the scope of the invention as recited by the claims.

In the depicted embodiment, wind speed measurement sensors 330 comprise anemometer entry 332 and anemometer exit 334, wherein wind speed measurement sensors 330 are integrated into vehicle 301 and/or the funnel system. Each of anemometer entry 332 and anemometer exit 334 may be one or more anemometers. Anemometers (e.g., anemometer entry 332 and anemometer exit 334) are posited at the entrance and the exit of the funnel system to measure the wind speed entering and leaving the funnel system, wherein this data is utilized to dynamically adjust or maintain the rotational speed of the wind turbine array. The anemometer entry 332 and anemometer exit 334 may be calibrated to ensure precise measurement. In various embodiments, anemometer entry 332 and anemometer exit 334 are integrated into the funnel system in a way that the positioning does not interfere with the funnel's operation or the wind flow. The data transmission of wind speed data (i.e., wind speed entry data 336 and wind speed exit data 338) from anemometer entry 332 and anemometer exit 334 to a computing system integrated into vehicle 301 occurs in real-time. In various embodiments, the wind speed data (i.e., wind speed entry data 336 and wind speed exit data 338) is encoded in a stand format for ease of integration with the computing system on vehicle 301. The real-time processing of sensor data is performed using software libraries by providing necessary speed and efficiency for real-time control. In various embodiments the windspeed data (i.e., wind speed entry data 336 and wind speed exit data 338) collected by anemometer entry 332 and anemometer exit 334 is utilized by component 150, via a computing system on vehicle 301, to dynamically adjust the funnel system via the servo motors.

FIG. 3D is a functional block diagram illustrating one embodiment of the present invention. FIG. 3D provides only an illustration of one implementation and does not imply any limitations with regard to the environments in which different embodiments may be implemented. Many modifications to the depicted environment may be made by those skilled in the art without departing from the scope of the invention as recited by the claims.

In the depicted embodiment, computing system 340 comprises data processing unit 341, control unit 342, communication unit 343, machine learning unit 344, and over-the-air (OTA) unit 345. In the depicted embodiment, data processing unit 341 generates and/or collects and controls sensor data 346, control unit 342 generates and/or collects and controls (e.g., sends) control data 348, communication unit 343 generates and/or collects and controls (e.g., sends) V2X communication data 350, machine learning unit 344 generates and/or collects and controls (e.g., sends) machine learning data 352, and OTA unit 345 generates and/or collects and controls (e.g., sends) OTA update data 354.

Data processing unit 341 may be a computing system programmed to continuously acquire wind speed data from the anemometers. Control unit 342 manages the control algorithm and dictates how the computing system should adjust the funnel's cross-sectional areas under different wind and vehicle speed conditions. Communication unit 343 manages the communication and control between the computing system and the hardware components installed in the vehicles. Machine learning unit 344 contains models trained on extensive data sets of wind patterns and road conditions, predict future wind patterns, and adjust the funnel accordingly. OTA unit 345 manages the communication and updates between the computing system and the hardware components built into the vehicle.

In various embodiments, computing system 340 is embedded in autonomous vehicle 301 and is connected to the wind turbine array, the funnel system motors, and the anemometers. Customized drivers may be developed to ensure seamless communication and control between computing system 340 and the hardware components described above. In various embodiments, based on a predetermined computation (e.g., Bernoulli's theorem) and the specific cut-in and cut-out wind speeds, control unit 342, via a control algorithm, dictates how computing system 340 should adjust the funnel's cross-sectional areas under identified wind and vehicle speed conditions.

In various embodiments, computing system 340 is programmed to continuously acquire wind speed data from the anemometers. Machine learning unit 344 may comprise machine learning models, trained on extensive data sets of wind patterns and road conditions, predict future wind patterns, and adjust the funnel accordingly. In various embodiments, standard communication protocols like Controller Area Network (CAN) and Bluetooth are utilized for data exchange between computing system 340 and other vehicle systems. In various embodiments, a real-time operating system is used to ensure computing system 340 can respond in real-time to changes in wind speed, vehicle speed, and funnel position.

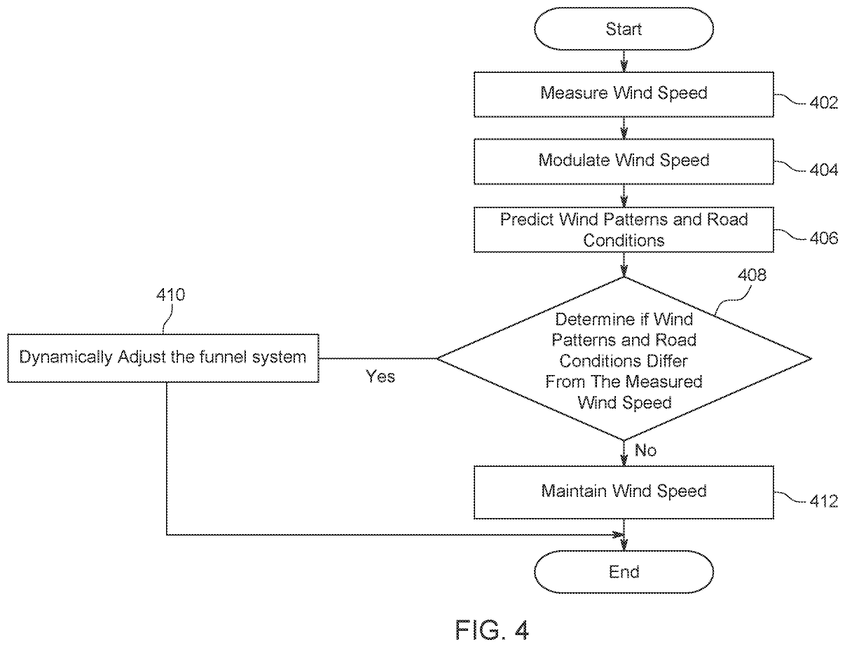

FIG. 4 illustrates operational steps of component 150, generally designated 400, in communication with client computer 101, remote server 104, private cloud 106, EUD 103, wind turbine array (turbine(s)) 161, funnel system 162, and/or public cloud 105, within distributed data processing environment 100, for optimizing power generation in a vehicle, in accordance with an embodiment of the present invention. FIG. 4 provides an illustration of one implementation and does not imply any limitations with regard to the environments in which different embodiments may be implemented. Many modifications to the depicted environment may be made by those skilled in the art without departing from the scope of the invention as recited by the claims.

In block 402, component 150 measures the wind speed of the air (e.g., wind) that is flowing around a vehicle. In various embodiments, component 150 measures the wind speed of the air (e.g., wind) that is flowing around a vehicle as the vehicle is in operation (e.g., driving down a road or highway). In various embodiments, component 150 measures the wind speed of the air (e.g., wind) that is flowing into a funnel system integrated into the vehicle as the vehicle is in operation (e.g., driving down a road or highway).

In block 404, component 150 modulates wind speed. In various embodiments, component 150 manipulates the shape (i.e., profile) of a funnel system (e.g., programmatically controlled funnel) integrated in front of a turbine or turbine array based on the measured wind speed entering and exiting the funnel system and Bernoulli's theorem. Component 150 may measure the wind speed that is passing through the funnel and may adjust the profile of the funnel system if the wind speed is identified as not being within a predetermined speed for power generation. For example, if the wind speeds are less than the cut-in-speed, then component 150 expands the entry cross-section and reduces the exit portion of the funnel system to ensure the wind speed meets the predetermined cut-in-speed. In another example, if the wind speeds are above the cut-out-speed, then component 150 reduces the entry cross-section and increases the exit portion of the funnel system to maintain the predetermined wind speed or slow the rate of turbine rotation so that the rotation speed of the turbine of the turbine array stays within a predetermined range of speed. For example, the predetermined range of speed (i.e., predetermined range of turbine rotation) is an optimal speed between 4 meters per second (m/s) and 5.8 m/s.

In block 406, component 150, predicts the wind patterns and road conditions associated with the vehicle. In various embodiments, component 150 predicts the wind patterns and road conditions associated with the path of a traveling vehicle, wherein the path of the traveling vehicle is predetermined. In various embodiments, component 150 collects data of the wind speed and road conditions via sensors (e.g., IoT sensors and anemometers) to provide real-time data to a vehicle's computing system. Component 150 may utilize the collected data to predict wind patterns and road conditions in real-time by employing machine learning models, control algorithms, Vehicle-to-everything (V2X) communication, and predictive analysis.

In block 408, component 150 determines if the wind patterns and road conditions differ from the measured wind speed. In various embodiments, component 150 determines if the predicted wind patterns and road conditions differ from the measured wind speed. Component 150 may employ machine learning models and control algorithms, using sensor data, V2X communication, to execute a predictive analysis of wind patterns and road conditions to proactively adjust the funnel system based on the output of the predictive analysis. In various embodiments, component 150, via an embedded computing system, receives inputs from the wind speed sensors, information about vehicle speed, and data from V2X systems for wind direction, vehicle direction, and forecasted weather conditions. Component 150 may calculate the optimal cross-sectional area of the funnel for the given circumstances based on the received inputs and/or predictive analysis and executes the motors controlling the funnel's shape based on the calculation and/or predictive analysis. In the depicted embodiment, if component 150 determines the predictive wind patterns and road conditions differ from the measured wind speed (Yes block) then component 150 advances to block 410. In the depicted embodiment, if component 150 determines the predictive wind patterns and road conditions do not differ from the measured wind speed (No block) then component 150 advances to block 412.

In block 410, component 150 dynamically adjusts the funnel system. In various embodiments, component 150 adjusts the cross-sectional area of the funnel's entry and exit points in real time, based on the measured relative wind speed entering the funnel system and/or the predicted wind patterns and road conditions. In various embodiments, the cross-sectional area of the entry and exit points of funnel system are adjustable, wherein based off data collected from IoT sensor set and/or anemometers, component 150 can adjust the entry and exit points of funnel system in real time using a motor system. Component 150, may utilize Bernoulli's theorem to dynamically adjust the entry and exit points of the funnel system to maintain a predetermined wind speed within the operational range of the turbines, thereby maximizing power generation. In various embodiments, component 150 adjusts the profile of the funnel system, based on identified wind speed and identified power generation, to regulate optimal wind speed feed to the turbines in the turbine array (i.e., to maintain optimal blade rotation of the turbine).

In various embodiments, if component 150 determines the wind speed is less than an identified cut-in-feed then component 150 adjusts the profile of the funnel system by expanding the entry cross-section of the funnel system and reducing the exit of the funnel system to increase the amount of wind and wind speed feed into the turbines. In various embodiments, if component 150 determines that the wind speeds are above the cut-out-speed, associated with the rotation of the blades of the turbines, then component 150 adjusts the profile of the funnel system by constricting the entry cross-section of the funnel system and increasing the exit of the funnel system to decrease the amount of wind speed being fed into the turbine array to reach or maintain a predetermined wind speed.

In block 412, component 150 maintains the wind speed by maintaining the current shape (e.g., profile) of the funnel system. In various embodiments, component 150 adjusts cross-sectional areas of the funnel system based on Bernoulli's theorem and the monitored wind speeds to maintain optimal wind speed and maximize power generation.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures (i.e., FIG.) illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
measuring, by a set of sensors, a wind speed as it passes through a funnel system;
modulating, by the funnel system, the wind speed of wind that passes through the funnel system to an array of wind turbines, wherein modulating the wind speed comprises:
adjusting, by a motor set, a cross-sectional area of an entry portion and an exit portion of the funnel system based on the measured wind speed; and
proactively adjusting, by a computing system, the funnel system to maintain a predetermined wind speed that is being fed to the array of wind turbines through the funnel system by employing machine learning models and control algorithms, using sensor data, vehicle to everything communication, and predictive analysis of wind patterns and road conditions.

2. The computer-implemented method of claim 1, wherein the array of wind turbines are embedded into a body of an autonomous vehicle, wherein the array of wind turbines generate power when exposed to wind and their operational range is defined by specific cut-in and cut-out wind speeds, wherein each turbine in the array of wind turbines is constructed out of lightweight composite material and strategically positioned to reduce aerodynamic drag while maximizing wind exposure.

3. The computer-implemented method of claim 1, wherein the funnel system is located in front of the array of wind turbines, and wherein the funnel system comprises a motor system.

4. The computer-implemented method of claim 1, wherein adjusting the cross-sectional area comprises:
utilizing Bernoulli's theorem to calculate a size or shape of the cross-sectional area of the funnel system; and
executing a motor system to adjust the cross-sectional area based on the calculated size or shape.

5. The computer-implemented method of claim 1, wherein the set of sensors comprise anemometers, wherein the anemometers are located at the entry portion and exit portion of the funnel system.

6. The computer-implemented method of claim 1, wherein the computing system is embedded and integrated into the vehicle and is designed to process sensor data in real-time.

7. The computer-implemented method of claim 1, further comprising:
collecting, by the sensor set, data associated with the wind speed and the road conditions to provide real-time data to the computing system; and
utilizing the collected data to predict wind patterns and road conditions in real-time by employing machine learning models, control algorithms, vehicle-to-everything (V2X) communication, and predictive analysis.

8. A computer system comprising:
one or more computer processors;
one or more computer readable storage devices;
program instructions to measure, by a set of sensors, a wind speed as it passes through a funnel system;
program instructions to modulate, by the funnel system, the wind speed of wind that passes through the funnel system to an array of wind turbines, wherein modulating the wind speed comprises:
program instructions to adjust, by a motor set, a cross-sectional area of an entry portion and an exit portion of the funnel system based on the measured wind speed; and
program instructions to proactively adjust, by a computing system, the funnel system to maintain a predetermined wind speed that is being fed to the array of wind turbines through the funnel system by employing machine learning models and control algorithms, using sensor data, vehicle to everything communication, and predictive analysis of wind patterns and road conditions.

9. The computing system of claim 8, wherein the array of wind turbines are embedded into a body of an autonomous vehicle, wherein the array of wind turbines generate power when exposed to wind and their operational range is defined by specific cut-in and cut-out wind speeds, wherein each turbine in the array of wind turbines is constructed out of lightweight composite material and strategically positioned to reduce aerodynamic drag while maximizing wind exposure.

10. The computing system of claim 8, wherein the funnel system is located in front of the array of wind turbines, and wherein the funnel system comprises a motor system.

11. The computing system of claim 8, wherein adjusting the cross-sectional area comprises:
program instructions to utilize Bernoulli's theorem to calculate a size or shape of the cross-sectional area of the funnel system to maintain the wind speed within an operational range of the turbines to maximize power generation; and
program instructions to execute a motor system to adjust the cross-sectional area based on the calculated size or shape of the cross-sectional area of the funnel system.

12. The computing system of claim 8, wherein the set of sensors comprise anemometers, wherein the anemometers are located at the entry portion and exit portion of the funnel system.

13. The computing system of claim 8, wherein the computing system is embedded and integrated into the vehicle and is designed to process sensor data in real-time.

14. The computing system of claim 8, further comprising:
program instructions to collect, by the sensor set, data associated with the wind speed and the road conditions to provide real-time data to the computing system; and
program instructions to utilize the collected data to predict wind patterns and road conditions in real-time by employing machine learning models, control algorithms, vehicle-to-everything (V2X) communication, and predictive analysis.

15. A computer program product comprising:
one or more computer readable storage devices and program instructions stored on the one or more computer readable storage devices, the stored program instructions comprising:
program instructions to measure, by a set of sensors, a wind speed as it passes through a funnel system;
program instructions to modulate, by the funnel system, the wind speed of wind that passes through the funnel system to an array of wind turbines, wherein modulating the wind speed comprises:
program instructions to adjust, by a motor set, a cross-sectional area of an entry portion and an exit portion of the funnel system based on the measured wind speed; and
program instructions to proactively adjust, by a computing system, the funnel system to maintain a predetermined wind speed that is being fed to the array of wind turbines through the funnel system by employing machine learning models and control algorithms, using sensor data, vehicle to everything communication, and predictive analysis of wind patterns and road conditions.

16. The computer product of claim 15, wherein the array of wind turbines are embedded into a body of an autonomous vehicle, wherein the array of wind turbines generate power when exposed to wind and their operational range is defined by specific cut-in and cut-out wind speeds, wherein each turbine in the array of wind turbines is constructed out of lightweight composite material and strategically positioned to reduce aerodynamic drag while maximizing wind exposure.

17. The computer product of claim 15, wherein adjusting the cross-sectional area comprises:
program instructions to utilize Bernoulli's theorem to calculate a size or shape of the cross-sectional area of the funnel system to maintain the wind speed within an operational range of the turbines to maximize power generation; and
program instructions to execute a motor system to adjust the cross-sectional area based on the calculated size or shape of the cross-sectional area of the funnel system.

18. The computer product of claim 15, wherein the set of sensors comprise anemometers, wherein the anemometers are located at the entry portion and exit portion of the funnel system.

19. The computer product of claim 15, wherein the computing system is embedded and integrated into the vehicle and is designed to process sensor data in real-time.

20. The computer product of claim 15, further comprising:
program instructions to collect, by the sensor set, data associated with the wind speed and the road conditions to provide real-time data to the computing system; and
program instructions to utilize the collected data to predict wind patterns and road conditions in real-time by employing machine learning models, control algorithms, vehicle-to-everything (V2X) communication, and predictive analysis.
